(19) United States
(12) Patent Application Publication
(10) Pub. No.: US 2024/0210219 A1
(43) Pub. Date: Jun. 27, 2024

(54) ADDRESSING DEVICE, OPTICAL FIBER ASSOCIATED WITH AN ADDRESSING DEVICE, AND SYSTEM AND METHOD FOR ADDRESSING OPTICAL FIBERS

(71) Applicant: OMNISENS S.A., Morges (CH)

(72) Inventor: Etienne ROCHAT, VALEYRES SOUS URSINS (CH)

(21) Appl. No.: 18/389,606

(22) Filed: Dec. 19, 2023

(30) Foreign Application Priority Data
Dec. 21, 2022 (EP) 22215690.3

(51) Int. Cl. G01D 5/353

(52) U.S. Cl. CPC G01D 5/35358; G01D 5/35316

(57) ABSTRACT

The disclosure concerns an addressing device arranged for being associated with an addressable optical fiber and arranged to give an optically coded address to the addressable optical fiber with which it is arranged to be associated, the optically coded address comprising a plurality of optical address digits, the addressing device being arranged so that each of the optical address digits is created by an address signal coming from the addressing device. The disclosure also relates to an optical fiber associated with an addressing device, and system and method for addressing optical fibers.

### TECHNICAL FIELD

The present disclosure relates to an addressing device.

The disclosure also relates to an optical fiber associated with an addressing device, and system and method for addressing optical fibers.

### STATE OF THE ART

One issue in an optical system having optical fibers distributed in different locations is the distance calibration or the localization of the different optical fibers. This is usually performed on the basis of the asset as built, by identifying specific points (manhole, splices if visible, connectors, offshore joint etc.). Points can be manually identified, for instance by tapping the asset (in Distributed Acoustic Sensing (DAS)) or by using cold spray (Distributed Temperature Sensing (DTS)) etc.

Considering a data center with a fiber optic cable (FOC) per cabinet basis, and assuming 100s of cabinet, using the as built-in data or doing manual localization becomes difficult, or at least time consuming and thus not economically viable. For instance, for temperature, one would have to make a cold spot (with a spray) at the beginning and the end of every single sensing cable whilst someone analyses the temperature measurement data to identify the position.

### SUMMARY OF THE DISCLOSURE

This disclosure presents a device, system or method for addressing optical fibers, compatible with uses of backscattered signals from these fibers, which are easier and/or faster and/or more practical to use compared to the state of the art.

An aspect of the disclosure concerns an addressing device arranged for being associated with an addressable device and arranged to give an optically coded address to the addressable device with which it is arranged to be associated, the optically coded address comprising a plurality of optical address digits, the addressing device being arranged so that each of the optical address digits is created by an address signal coming from the addressing device.

The addressable device can be an addressable optical fiber.

The addressing device according to the disclosure can comprise several optical sections.

Each address signal of each digit can come from a different optical section.

Each address signal of each digit can be a signal equal to or proportional to or depending on:
a wavelength or frequency or wavenumber of a backscattered signal, such as a Brillouin or Raman or Rayleigh backscattered signal, or
a wavelength or frequency or wavenumber of a back reflection signal, or
an intensity loss of a backscattered signal, such as a Brillouin or Raman or Rayleigh backscattered signal.

Each address signal can be a Brillouin backscattered signal.

The value of each optical address digit can depend on:
a Brillouin frequency shift and/or
a material and/or structure and/or
a physical parameter
of a section of optical fiber, among several sections of optical fibers in the addressing device, coding for this optical address digit.

The addressing device according to the disclosure can comprise different sections of optical fibers optically linked in series and having respectively:
different Brillouin frequency shifts and/or
different materials and/or different structures and/or
different physical parameters each maintained at a given value.

The addressing device according to the disclosure can comprise different sections of optical fibers linked in series wherein to each section is applied a different strain. In this embodiment:
the different sections of optical fibers can be part of a continuous optical fiber, and/or
each section can comprise a length of optical fiber glued with a given elongation around an object.

The value of each optical address digit can depend on a presence or absence of a specific type of Fiber Bragg Grating inside the addressing device and/or on a presence or absence of a Fiber Bragg Grating at a specific location inside the addressing device among several specific locations in the addressing device.

The addressing device according to the disclosure can comprise several Fiber Bragg Gratings optically linked in series.

Each optical address digit:
can be a bit having only two possible values, or
can have at least three possible values.

An aspect of the disclosure concerns an addressable optical fiber associated with an addressing device according to the disclosure.

The addressable optical fiber according to the disclosure can be surrounded:
by its associated addressing device on one end of the addressable optical fiber, and
by a stop device on the other end of the addressable optical fiber, the stop device being arranged for coding for an end of the addressable optical fiber with a least one end digit created by an end signal coming from the stop device.

An aspect of the disclosure concerns a system for addressing optical fibers, comprising:
a plurality of addressable optical fibers arranged for light to travel through them along an optical path,
an addressing device according to the disclosure per addressable optical fiber:
   each addressing device associated with an addressable optical fiber being arranged to give an optically coded address to the addressable optical fiber with which it is associated different from the address(es) of the other addressable optical fiber(s),
   each associated addressing device and addressable optical fiber forming a part of the optical path distinct from the other parts of the optical path,
   each address comprising a plurality of optical address digits, each addressing device being arranged so that each of the optical address digits of the address given by this addressing device is created by an address signal coming from this addressing device,
an analysis device arranged to:
   receive at least one fiber backscattered signal from at least one of the addressable optical fibers, and
   for each addressable optical fiber from which a fiber backscattered signal is received, identify and/or localize this addressable optical fiber by using the address signals of the optical address digits coding for the address of this addressable optical fiber.

Each addressable optical fiber can be surrounded, along the optical path:
by its associated addressing device on one end of the addressable optical fiber, and
by a stop device on the other end of the addressable optical fiber, the stop device being arranged for coding for an end of the addressable optical fiber with a least one end digit created by an end signal coming from the stop device.

An aspect of the disclosure concerns a method for addressing optical fibers, implemented in a system comprising:
a plurality of addressable optical fibers arranged for light to travel through them along an optical path,
an addressing device according to the disclosure per addressable optical fiber
each associated addressing device and addressable optical fiber forming a part of the optical path distinct from the other parts of the optical path,
the method comprising:
   for each addressing device associated with an addressable optical fiber, generating an optically coded address to the addressable optical fiber with which it is associated different from the address(es) of the other addressable optical fiber(s), each address comprising a plurality of optical address digits, each optical address digit being created by an address signal coming from the addressing device,
receiving at least one fiber backscattered signal from at least one of the addressable optical fibers, and
for at least one or each addressable optical fiber from which a fiber backscattered signal is received, identifying and/or localizing this addressable optical fiber by using the address signals of the optical address digits coding for the address of this addressable optical fiber.

The fiber backscattered signal from at least one of the addressable optical fibers and each address signal can be generated from the same excitation signal or pump signal.

Each addressing device can comprise several optical sections.

Each address signal of each digit can come from a different optical section.

Each address signal of each digit can be a signal equal to or proportional to or depending on:
a wavelength or frequency or wavenumber of a backscattered signal, such as a Brillouin or Raman or Rayleigh backscattered signal, or
a wavelength or frequency or wavenumber of a back reflection signal, or
an intensity loss of a backscattered signal, such as a Brillouin or Raman or Rayleigh backscattered signal.

Each address signal can be a Brillouin backscattered signal.

The value of each optical address digit can depend on:
a Brillouin frequency shift and/or
a material and/or structure and/or
a physical parameter
of a section of optical fiber, among several sections of optical fibers in the addressing device, coding for this optical address digit.

Each addressing device can comprise different sections of optical fibers optically linked in series and having respectively:
different Brillouin frequency shifts and/or
different materials and/or different structures and/or
different physical parameters each maintained at a given value.

Each addressing device can comprise different sections of optical fibers linked in series wherein to each section is applied a different strain. In this embodiment, for each addressing device:
the different sections of optical fibers can be part of a continuous optical fiber, and/or
each section can comprise a length of optical fiber glued with a given elongation around an object.

The value of each optical address digit can depend on a presence or absence of a specific type of Fiber Bragg Grating inside the addressing device and/or on a presence or absence of a Fiber Bragg Grating at a specific location inside the addressing device among several specific locations in the addressing device.

Each addressing device can comprise several Fiber Bragg Gratings optically linked in series along the optical path.

Each optical address digit:
can be a bit having only two possible values, or
can have at least three possible values.

Each addressable optical fiber can be surrounded, along the optical path:
by its associated addressing device on one end of this addressable optical fiber, and
by a stop device on the other end of this addressable optical fiber, the stop device being arranged for coding for an end of the addressable optical fiber with a least one end digit created by an end signal coming from the stop device.

### BRIEF DESCRIPTION OF THE FIGURES

Other advantages and characteristics of the disclosure will appear upon examination of the detailed description of embodiments which are in no way limitative, and of the appended drawings in which:

FIG. 1 illustrates a first embodiment of a system 20 according to the disclosure (which is a best realization mode), comprising several addressing devices 1 according to the disclosure, each addressing device 1 being associated with an addressable optical fiber 15; system 20 is not necessary a closed loop: fiber 23 is optional and can be deleted if no probe signal is needed in system 20;

FIG. 2 illustrates a first example of two optically coded addresses 30, each address 30 comprising a plurality of optical address digits 31, 32, 33, 34,

FIG. 3 illustrates a second example of optically coded address 30 comprising a plurality of optical address digits 31, 32, 33, 34,

FIGS. 4a and 4b illustrates a third example of optically coded address 30 comprising a plurality of optical address digits 31, 32, 33, 34,

FIG. 5 illustrates a second embodiment of a system 20 according to the disclosure, comprising several addressing devices 1 according to the disclosure, each addressing device 1 being associated with an addressable optical fiber 15,

FIG. 6 illustrates real data for the first example of two optically coded addresses, each address comprising four optical address digits,

FIG. 7 illustrates real data for the first example of two optically coded addresses, each address comprising four optical address digits, and

FIG. 8 illustrates three sections 11, 12, 13 of a fiber 71 in the case for which each address signal is a Brillouin backscattered signal and the value of each optical address digit respectively 31, 32, 33 depends on a physical parameter such like strain.

These embodiments being in no way limitative, we can consider variants of the disclosure including only a selection of characteristics subsequently described or illustrated, isolated from other described or illustrated characteristics (even if this selection is taken from a sentence containing these other characteristics), if this selection of characteristics is sufficient to give a technical advantage or to distinguish the disclosure over the state of the art. This selection includes at least one characteristic, in some implementations, a functional characteristic without structural details, or with only a part of the structural details if that part is sufficient to give a technical advantage or to distinguish the disclosure over the state of the art.

### DETAILED DESCRIPTION

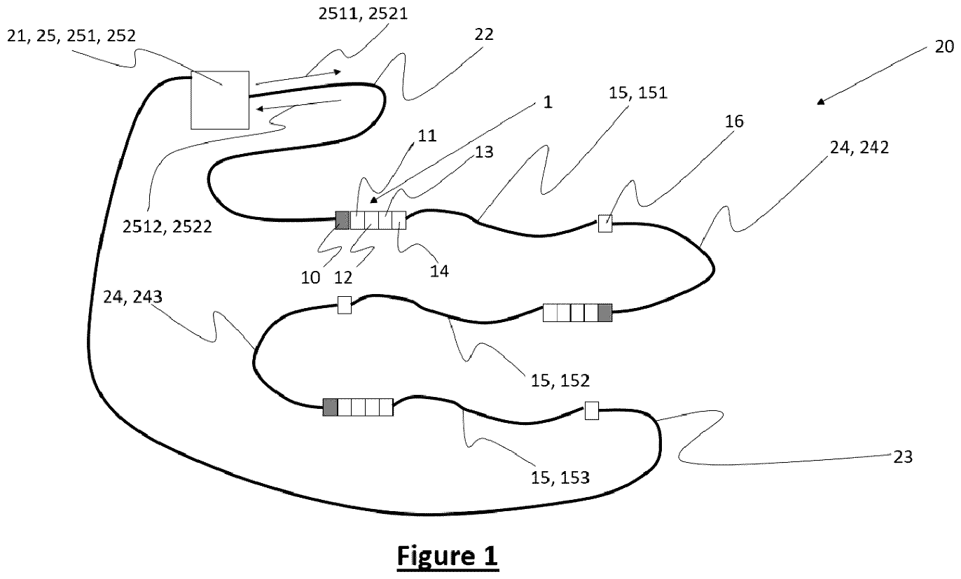

We are now going to describe, in reference to FIGS. 1 to 3, 4a, 4b, 6, 7 and 8 a first embodiment of a system 20 according to the disclosure (which is a best realization mode), comprising several addressing devices 1 according to the disclosure, each addressing device 1 being associated with an addressable optical fiber 15.

The system 20 for addressing optical fibers 15 comprises a plurality of addressable optical fibers 15 arranged for light to travel through them along an optical path; in FIG. 1, we see a first addressable optical fiber 151, a second addressable optical fiber 152 and a third addressable optical fiber 153 optically linked in series along the optical path.

The system 20 for addressing optical fibers comprises an addressing device 1 per addressable optical fiber 15.

Each addressable optical fiber 15 is surrounded:
by its associated addressing device 1 on one end of this addressable optical fiber 15, and
by an associated stop device 16 on the other end of this addressable optical fiber 15, the stop device 16 being arranged for coding for an end of the addressable optical fiber 15 with a least one end digit 36 created by an end signal coming from at least a part of the stop device 16.

The first embodiment of addressing device 1 according to the disclosure can be claimed, protected and/or marketed according to the disclosure:
alone, and/or
with its associated addressable optical fiber 15, and/or
with its associated end device 16, and/or
with its associated addressable optical fiber 15 and end device 16.

For each fiber 15, the associated addressing device 1 and/or the associated end device 16 can be attached to this fiber 15 by connection means allowing them to be connected and disconnected from this optical fiber 15 (for example for changing an address) by use of any known fiber connector, or it can be attached and secured in a non-removable manner to this optical fiber 15 (for example through a fiber splicing).

Each addressing device 1 associated with an addressable optical fiber 15 is arranged to give an optically coded address 30 to the addressable optical fiber 15 with which it is associated different from the address(es) 30 of the other addressable optical fiber(s) 15.

Each associated addressing device 1 and addressable optical fiber 15 (and stop device 16) form a part of the optical path distinct from the other parts of the optical path formed by the other associated addressing device 1 and addressable optical fiber 15 (and stop device 16).

Each associated addressing device 1 and addressable optical fiber 15 can be directly optically connected without any intermediate parts.

Each associated addressing device 1 and stop device 16 can be directly optically connected without any intermediates.

In some embodiments, each addressing device 1 is closer, along the optical path, to the addressable optical fiber 15 with which it is associated than to the other addressable optical fibers 15.

Each optically coded address 30 comprises a plurality of optical address digits 31, 32, 33, 34, each addressing device 1 being arranged so that each of the optical address digits 31, 32, 33, or 34 of the address given by this addressing device 1 is created by an address signal coming from this addressing device 1, more precisely from a part of the addressing device 1 corresponding to this optical address digit 31, 32, 33 or 34.

In some embodiments, system 20 uses backscattered signals 2512 from the optical fibers 15. In some embodiments, system 20 is arranged for measuring at least one strain and/or temperature in the optical fibers 15 by use of these backscattered signals 2512.

System 20 comprises an emitting device 25 comprising:
emitting device 251 for emitting at least one excitation signal 2511 (also called fiber excitation signal 2511), the fiber excitation signal 2511 generating the fiber backscattered signal 2512 used (by analysis device 21) for measuring a parameter (strain, temperature, vibration, etc.) into at least one of the optical fibers 15, and
emitting device 252 for emitting at least one excitation signal 2521 (also called addressing excitation signal 2521) used for generating the address signal 2522 of each digit 31, 32, 33 or 34.

The fiber excitation signal 2511 and the addressing excitation signal 2521 can be the same signal, or can be different signals.

The fiber backscattered signal 2512 and the address signal 2522 can be the same signal, or can be different signals.

Emitting devices 251 and 252 can be the same device or different devices.

In some embodiments, emitting device 251 can comprise:
an emitting device (e.g. a laser) arranged for emitting a pump signal (e.g. a pulsed pump signal) in the optical path, in some implementations, arranged for injecting this pump signal in a first end (corresponding to optical fiber 22, which is also part of the optical path) of the optical path; thus pump signal is thus one fiber excitation signal 2511 and is arranged for generating the fiber backscattered signal 2512 in the fibers 15, and
if necessary (in case of BOTDA or BOFDA, or BOCDA), an emitting device (e.g. a laser) arranged for emitting a probe signal (e.g. a continuous probe signal) in the optical path, in some implementations, arranged for injecting this probe signal in a second end (corresponding to optical fiber 23, which is also part of the optical path) of the optical path; this probe signal is thus another fiber excitation signal 2511.

In some embodiments, emitting device 252 can comprise:
an emitting device (e.g. a laser) arranged for emitting a pump signal (e.g. a pulsed pump signal) in the optical path, in some implementations, arranged for injecting this pump signal in a first end (corresponding to optical fiber 22, which is also part of the optical path) of the optical path; thus pump signal is thus one addressing excitation signal 2521 and is arranged for generating the address signal 2522 of each digit 31, 32, 33 or 34, and
if necessary (in case of BOTDA or BOFDA, or BOCDA), an emitting device (e.g. a laser) arranged for emitting a probe signal (e.g. a continuous probe signal) in the optical path, in some implementations, arranged for injecting this probe signal in a second end (corresponding to optical fiber 23, which is also part of the optical path) of the optical path; this probe signal is thus another addressing excitation signal 2521.

The sets (formed individually by associated addressing device 1, fiber 15 and stop device 16) are optically linked together two by two by an optical fiber link 24, which is also part of the optical path.

System 20 comprises an analysis device 21 arranged to:
receive at least one fiber backscattered signal 2512 from at least one of the addressable optical fibers 15, and
for each addressable optical fiber 15 from which a fiber backscattered signal is received, identify and/or localize this addressable optical fiber 15 by using the address signals 2522 of the optical address digits 31, 32, 33, 34 coding for the address 30 of this addressable optical fiber 15.

In some implementations, analysis device 21 comprise at least one optical detector, and at least one among one computer, one central processing or computing unit, one analogue electronic circuit (in some implementations, dedicated), one digital electronic circuit (in some implementations, dedicated) and/or one microprocessor (in some implementations, dedicated) and/or software means.

System 20 comprises thus at least one interrogator 21, 25 comprising the emitting device 25 and the analysis device 21.

Emitting device 251 combined with analysis device 21, in some implementations, comprise a Distributed Fiber Optic Sensor, an Optical Time Domain Reflectometer (OTDR), optical frequency domain reflectometer (OFDR), a Distributed Acoustic Sensing (DAS) sensor, a Distributed Temperature Sensing (DTS) sensor, a Distributed Strain Sensing (DSS) sensor, a Brillouin Optical Time Domain Analyzer (BOTDA), a Brillouin Optical Frequency Domain Analyzer (BOFDA), a Brillouin Optical Time Domain Reflectometer (BOTDR), and/or a Brillouin Optical Frequency Domain Reflectometer (BOFDR), a Brillouin optical correlation domain reflectometer (BOCDR), and/or a Brillouin optical correlation domain analyzer (BOCDA).

Emitting device 252 combined with analysis device 21, in some implementations, comprise a Distributed Fiber Optic Sensor, an Optical Time Domain Reflectometer (OTDR), optical frequency domain reflectometer (OFDR), a Distributed Acoustic Sensing (DAS) sensor, a Distributed Temperature Sensing (DTS) sensor, a Distributed Strain Sensing (DSS) sensor, a Brillouin Optical Time Domain Analyzer (BOTDA), a Brillouin Optical Frequency Domain Analyzer (BOFDA), a Brillouin Optical Time Domain Reflectometer (BOTDR), and/or a Brillouin Optical Frequency Domain Reflectometer (BOFDR), a Brillouin optical correlation domain reflectometer (BOCDR), a Brillouin optical correlation domain analyzer (BOCDA), and/or a fiber Bragg Grating interrogator.

Each addressing device 1 is thus arranged for being associated with an addressable optical fiber 15 and is thus arranged to give an optically coded address 30 to the addressable optical fiber 15 with which it is arranged to be associated or with which it is associated.

Each optically coded address 30 comprises a plurality of optical address digits 31, 32, 33, 34, each addressing device 1 being arranged so that each of the optical address digits 31, 32, 33 or 34 of the address given by this addressing device 1 is created by an address signal coming from the addressing device 1, more precisely coming from a part of the addressing device 1 corresponding to this address optical digit 31, 32, 33 or 34.

Each addressing device 1 comprises several optical sections optically linked in series along the optical path.

Each address signal of each digit 31, 32, 33 or 34 comes from a different optical section.

Each address signal 2522 of each digit 31, 32, 33 or 34 is a signal equal to or proportional to or depending on:
a wavelength or frequency or wavenumber of a backscattered signal, such as a Brillouin or Raman or Rayleigh backscattered signal, generated from the excitation signal 2521 for example generated from the pump signal of generator 252, or
a wavelength or frequency or wavenumber of a back reflection signal of an excitation signal 2521 for example of the pump signal of generator 252, or
an intensity loss of a backscattered signal, such as a Brillouin or Raman or Rayleigh backscattered signal (in some implementations, a Raman or Rayleigh backscattered signal), generated from the excitation signal 2521 for example generated from the pump signal of generator 252.

Each end signal of each end digit 36 coming from a stop device 16 can have the same nature than each address signal 2522, i.e. is respectively a signal equal to or proportional to or depending on:
a wavelength or frequency or wavenumber of a backscattered signal, for example a Brillouin or Raman or Rayleigh backscattered signal, generated from the excitation signal 2521 for example generated from the pump signal of generator 252 or
a wavelength or frequency or wavenumber of a back reflection of excitation signal 2521, for example of the pump signal of generator 252 or
an intensity loss of a backscattered signal, such as a Brillouin or Raman or Rayleigh backscattered signal, generated from the excitation signal 2521 for example generated from the pump signal of generator 252.

As each fiber optic cable (FOC) 15 has a section of fiber at both ends (device 1 at one end and device 16 at the other end) that is easily measured directly by the interrogator comprising emission device 25 and analysis device 21 using directly the DTS/DSS/DAS or that can be read with an OTDR or a FBG interrogator and transferred to the DTS/DSS/DAS, it makes configuration easier.

Ideally, the START end of each fiber 15, i.e. its addressing device 1, has an address 30 made of several digits 31, 32, 33, 34, for example 4 digits providing at least 16 addresses (binary) or more (if the digits have multilevel). Similarly, the STOP end of each fiber 15, i.e. its stop device 16, has an address made of at least one digit 36, for example a single STOP digit can identify the end of the measurement section 15 and also provide a direction (that can be measured from the START end 1 to the STOP end 16).

The type of digit 31, 32, 33, 34, 36 is technology dependent.

Each optical address digit 31, 32, 33, 34 (and end 36):
can be a bit having only two possible values, or
can have at least three possible values.

The value of each optical address digit 31, 32, 33, 34 (and end 36) can be a number (0 or 1 for a bit, or more generally 1, 2, 3, 4, etc.) or not (for example “YES” or “NOT” for a bit; or “FIRST TYPE OF OPTICAL FIBER”, “SECOND TYPE OF OPTICAL FIBER”, “THIRD TYPE OF OPTICAL FIBER”, “FOURTH TYPE OF OPTICAL FIBER”, etc. ; or “FIRST TYPE OF FIBER BRAGG GRATING”, “SECOND TYPE OF FIBER BRAGG GRATING”, “THIRD TYPE OF FIBER BRAGG GRATING”, “FOURTH TYPE OF FIBER BRAGG GRATING”, etc.).

System 20 allows:
identifying uniquely one sensing fiber 15 within a daisy chain of fibers 15
finding the sensing direction by providing a “START” and a “STOP” position
reading each address 30 with an interrogator 21, 25, such as a DTS, DSS, or DAS interrogator 21, 25
no need for in field localization of the start/end and direction of each sensing section
Pre-calibration of sensing fiber 15 with known address, allowing then this sensing fiber to be deployed on an installation and then quickly identified and located with known calibration,
automatic configuration based on START/STOP signal detection for automatic mapping of several sensing fiber 15 and their addresses,
fast installation/configuration.

The embodiment of method for addressing optical fibers, implemented in system 20 of FIG. 1, comprises:
for each addressing device 1 associated with an addressable optical fiber 15, generating an optically coded address 30 to the addressable optical fiber 15 with which it is associated different from the address(es) 30 of the other addressable optical fiber(s) 15, each address 30 comprising a plurality of optical address digits 31, 32, 33, 34, each optical address digit 31, 32, 33, 34 being created by an address signal coming from the addressing device 1,
receiving at least one fiber backscattered signal from at least one of the addressable optical fibers 15, and
for at least one or each addressable optical fiber 15 from which a fiber backscattered signal is received, identifying and/or localizing this addressable optical fiber 15 by using the address signals of the optical address digits 31, 32, 33, 34 coding for the address 30 of this addressable optical fiber 15.

In some embodiments, the fiber backscattered signal from at least one of the addressable optical fibers 15 and each address signal are generated from the same excitation signal or pump (and probe) signal from emitting device 25.

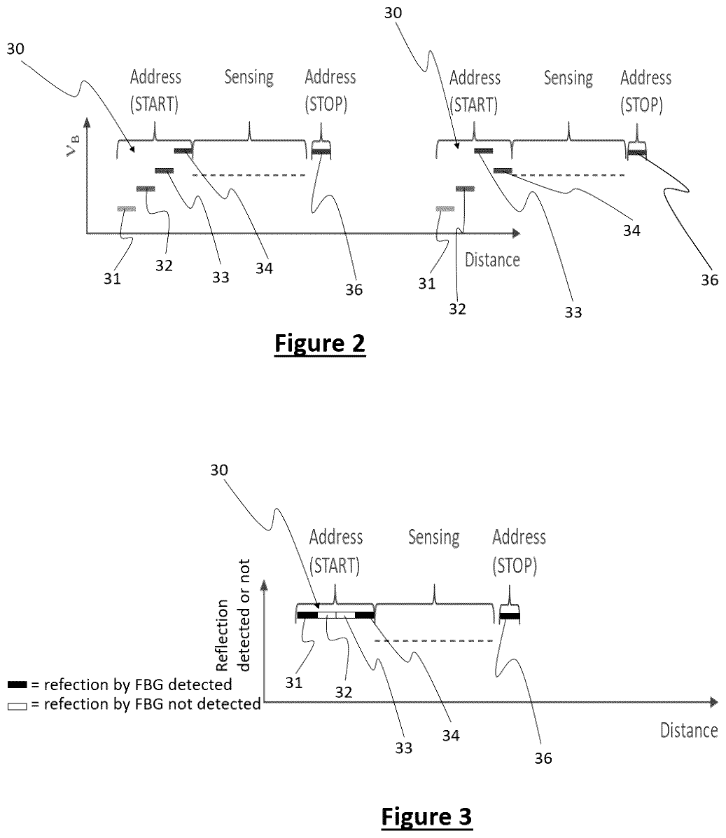

We are now going to describe with more details the first, second, and third examples of address 30. In FIGS. 2, 3, 4a and 4b, we supposed that each addressing device 1 comprises as illustrated in FIG. 1 at least four optical sections (first optical section 11, then second optical section 12, then third optical section 13, the fourth optical section 14) optically linked in series along the optical path. For the second example of FIG. 3, each addressing device 1 further comprises, before (along the optical path) sections 11, 12, 13, 14, an initial optical section 10 not coding for the address 30 but indicating that an address follows.

We are now going to describe with more details the first example of address 30.

The first example of address 30 is illustrated in FIG. 2.

In this first example:
emitting devices 251 and 252 are a same and common emitting device 25
The fiber excitation signal 2511 and the addressing excitation signal 2521 are the same signal, for example a laser signal
the system 20 is a Brillouin system, in some implementations, a Brillouin DTS system 20:
interrogator 21, 25 is, in some implementations, a Brillouin DTS interrogator
the fiber backscattered signal 2512 from fiber 151, 152 and/or 153 is a Brillouin backscattered signal, and
the address signal 2522 for each digit of the address 30 from each addressing device 1 is a Brillouin backscattered signal
Analysis device 21 is arranged for analyzing (or is analyzing) the fiber backscattered signal 2512 and each address signal 2522.

Brillouin is based on the measurement of the so-called Brillouin frequency shift. In silica glass, the Brillouin shift v_{B} is e.g., 10.8 GHz at a wavelength of 1550 nm. Pure silica fibers have a shift of 11 GHz. Some fibers (DRAKA BB-XS), due to their manufacturing process have, e.g., a shift of 10.6 GHz. Thus, by carefully selecting different fibers, a multilevel digit address 30 can be built.

In the first example of address 30, each address signal is a Brillouin backscattered signal and the value of each optical address digit 31, 32, 33, 34 depends on:
a Brillouin frequency shift and/or
a material (for example with a specific optical index) and/or structure (for example with or without hollow part and/or tubular part and/or photonic crystals and/or microstructured clad) (the Brillouin frequency shift being given by the material and/or structure) and/or
a physical parameter, for example at least one among:
   temperature, for example by applying different temperatures on the four sections 11, 12, 13, 14 of fiber by using four different ovens
   strain, for example by applying elongation (pulling) on the four sections 11, 12, 13, 14, with different pulling forces
   vibration, for example by coiling each section 11, 12, 13, 14 around a piezo-electric cylinder, each cylinder being excited at a different frequency,
      of a section of optical fiber, among several sections respectively 11, 12, 13, 14 of optical fibers in the addressing device, coding for this optical address digit respectively 31, 32, 33, 34. In this case, each section 11, 12, 13, or 14 of optical fiber is one of the optical sections of the addressing device 1 optically linked in series along the optical path.

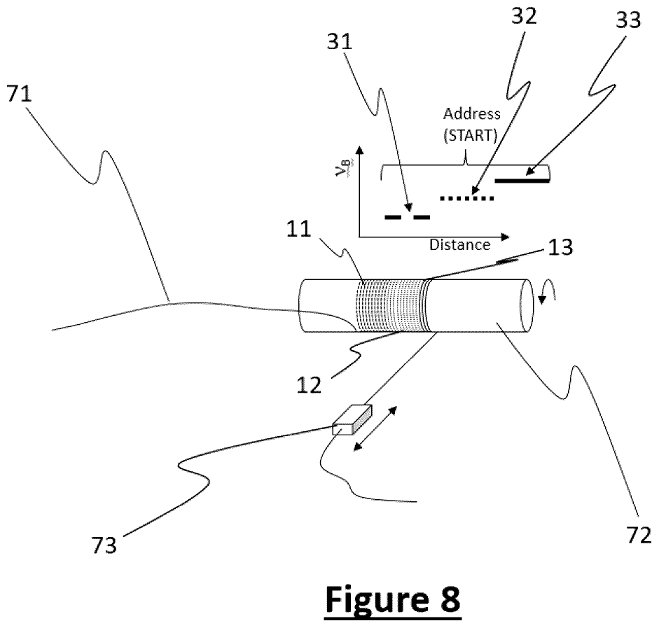

For example, FIG. 8 illustrates the case for which each address signal is a Brillouin backscattered signal and the value of each optical address digit respectively 31, 32, 33 (only three digits in the example of FIG. 8) depends on a physical parameter, such like strain, of a section respectively 11, 12, 13. Using a bend insensitive fiber 71 (for the three sections 11, 12, 13) that can be coiled around a small diameter 72 (e.g., a steel cylinder 72), in some implementations, 10 mm or less, for example 5 mm, the address can be defined by coiling and gluing fiber 71 around a cylinder 72 whilst applying controlled tension. Starting with a define Brillouin frequency, for instance 10.8 GHz at 1550 nm for most single-mode fiber, a first length 11 (e.g., of 1 m) of fiber 71 is coiled around the cylinder 72 with a given elongation (controlled by a tension mechanism 73 such like a spring) and secure with glue. Then tension is modified (increased in FIG. 8) and another length 12 (e.g., of 1 m) of fiber 71 is coiled. Finally, tension is changed (increased in FIG. 8) one more time and a third section 13 (e.g., of 1 m) of fiber 71 is glued (shown in FIG. 8 with the tension on the coiled and not yet coiled section). This results in a 3 digits-3 level address system with no splice, no additional loss, small form factor. In other embodiments two or more digits and/or two or more levels can be employed. Since the fiber 71 is continuous, there is no additional splice loss between the digits 31, 32, 33 as in the other example based on material or structure difference(s). In addition, by using a bend insensitive fiber, bending loss are kept low too. Less loss means also that more systems can be measured using the same interrogator. Thus, in this case, each section 11, 12, 13 comprises a length (or a same length, for example 1 m each) of optical fiber glued with a given elongation (in some implementations, around an object, in some implementations, such like a cylinder); all these sections 11, 12, 13 are in some implementations, lengths of a same optical fiber 71. In case of FIG. 8, the addressing device 1 comprises different sections 11, 12, 13 of optical fibers linked in series wherein to each section 11, 12, 13 is applied a different strain. The different sections 11, 12, 13 of optical fibers are part of a continuous optical fiber 71. Each section 11, 12, or 13 comprises a length of optical fiber glued or immobilized or fixed with a given elongation or strain (for example around an object 72).

In the first example of address 30, each end signal is a Brillouin backscattered signal and the value of each end digit 36 depends on:
a Brillouin frequency shift and/or
a material and/or structure, and/or
and/or physical parameter (each section 11, 12, 13, 14 being equipped with a device arranged for maintaining constant this physical parameter of the section, such like a thermostat or a pressure controller, an oven, pulling means, piezo-electric cylinder, etc. as previously described)
   of a section of optical fiber in the stop device 16, coding for this end digit 36.

The address 30 is coded this way: the value of the n^{th} digit of the address 30 is i, i being an integer corresponding to a specific type of section of optical fiber having a specific value of Brillouin frequency shift v_{B} detected at the n^{th} optical section 11, 12, 13, or 14 by analysis device 21.

The digit spatial length should be compatible with the spatial resolution of the interrogator 21, 25. For instance, should the system 20 work with 2 meters spatial resolution (SR), then the digit length should be slightly longer than 2 m (technically, should be the SR+sampling length, e.g., 2.5 m in this case) to make sure that the address digit 31, 32, 33 or 34 is read.

FIG. 2 is an example:
assuming 4 different Brillouin shifts for each digit respectively 31, 32, 33, 34 corresponding to each optical section respectively 11, 12, 13, 14 of the addressing device 1, and
assuming a pure silica fiber as stop digit 36 corresponding to the stop device 6.

For example, in the left part of FIG. 2, the address of fiber 151 comprises four digits and is “1” “2” “3” “4” (but it could also be “FIRST TYPE OF OPTICAL FIBER” “SECOND TYPE OF OPTICAL FIBER” “THIRD TYPE OF OPTICAL FIBER” “FOURTH TYPE OF OPTICAL FIBER”) and in the right part of FIG. 2 the address of fiber 152 comprises four digits and is “1” “2” “4” “3”.

In the first example of address 30, each or at least one of the addressing devices 1 comprises different sections 11, 12, 13, 14 of optical fibers optically linked in series along the optical path and in some implementations, (but not necessarily, as the address “1” “1” “1” “1” is a possible address) having different Brillouin frequency shifts and/or different materials and/or structures.

The lead in fiber (22 for fiber 151, 242 for fiber 152, and 243 for fiber 153) can have any shift (including those of the address digits 31, 32, 33, 34 corresponding to each optical section respectively 11, 12, 13, 14) and the sensing fiber 15 as well. Practically, addressing digit 31 must have a different shift from lead in fiber so that it can be read.

Thus, if lead in fiber 22 corresponds to digit 31=1, then the address of type 1xxx are forbidden. Other design rules are possible too; for instance, digit 32=2 in all conditions. In this case, as the length of the digit and the total number of digits are known, the address can be read.

The first digit 31 of addressing device 1 of fiber respectively 151, 152, 153 should be different from the signal generated in the previous (along the optical path) fiber respectively 22, 242, 243.

The STOP digit 36 of stop device 16 of fiber respectively 151, 152, 153 should be different from fiber the signal generated by following (along the optical path) fiber respectively 242, 243, 23.

This scheme provides as many as 4⁴=256 addresses, but the START address 0001 is forbidden as is the same as the STOP one (loosing direction).

Similarly, the address 0000 is forbidden, as the START cannot be found.

Thus, 254 addresses and fibers 15 can be distinguished.

In the first example of address 30 each addressing device 1 comprises different sections 11, 12, 13, 14 of optical fibers optically linked in series along the optical path and these sections 11, 12, 13, 14 includes at least two sections of optical fibers having:
at least two different Brillouin frequency shifts and/or
at least two different materials and/or structures
   that also differ from all the Brillouin frequency shift(s) and/or material(s) and/or structure(s) of fiber 15 with which this addressing device 1 is associated with.

In the first example of address 30 each stop device 1 comprises at least one section of optical fiber having:
a Brillouin frequency shifts and/or
a material and/or structure
   that differs from all the Brillouin frequency shift(s) and/or material(s) and/or structure(s) of fiber 15 with which this addressing device 1 is associated with.

In practice (at a wavelength of 1550 nm for the excitation pump signal), pure silica fibers have a ˜11 GHz Brillouin frequency; most single mode fibers (SMF) have a ˜10.8 GHz and a few bend-insensitive fibers have a ˜10.6 GHz frequency. This provides a 3-level address system. Intermediate frequencies are available, thanks to the different manufacturing process and to the intrinsic dispersion in the manufacturing so that, in practice, at least or even more than 6 levels could be made available.

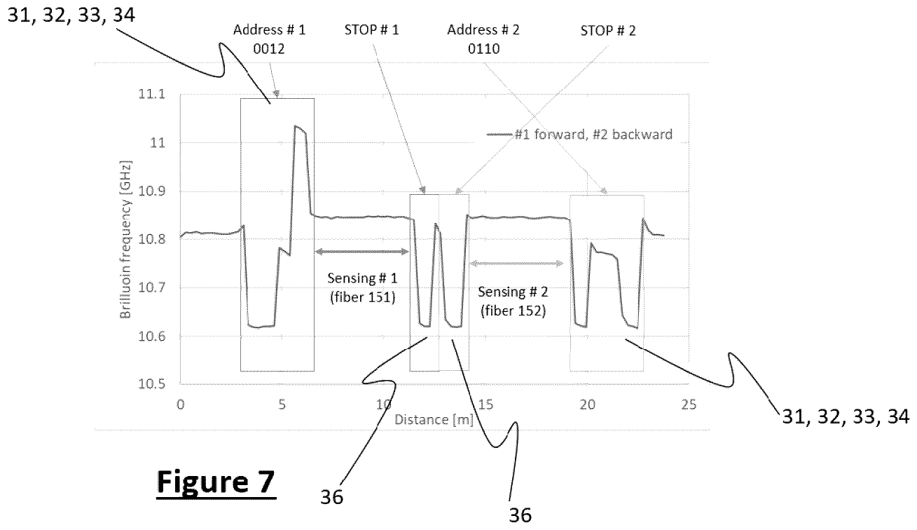

FIGS. 6 and 7 illustrate real data for the first example of two optically coded addresses of the two previously described fibers 151, 152, each address comprising four optical address digits.

In FIGS. 6 and 7:
digit “0” corresponds to a Brillouin frequency of 10.65 GHz,
digit “1” corresponds to a Brillouin frequency of 10.75 GHz,
digit “2” corresponds to a Brillouin frequency of 11.02 GHz,
the address of fiber 151 is “0012”,
the address of fiber 152 is “0110”,
in FIG. 7, the direction of fiber 152 has been reversed compared to FIG. 6, showing that the orientation of fiber 152 can be found.

Even the previously described first example of address 30 concerns the case where the fiber backscattered signal 2512 and the address signal 2522 are a same Brillouin backscattered signal, the case of the previously described first example of address 30 (for which the value of each optical address digit depends on a material and/or structure and/or parameter of a section of optical fiber, among several sections of optical fibers in the addressing device, coding for this optical address digit) can be generalized:
fiber backscattered signal 2512 can be a Brillouin backscattered signal, a Raman Backscattered signal, or a Rayleigh Backscattered signal, for various possibilities a measured parameters (temperature, strain, vibration, etc.) of fiber(s) 15, and/or
address signal 2522 can be a signal equal to or proportional to or depending on, by order of preference:
   a wavelength or frequency or wavenumber of a Brillouin backscattered signal, because Brillouin frequency is the most sensitive to fiber type,
   a wavelength or frequency or wavenumber of Raman or Rayleigh backscattered signal, because some specific sections of optical fibers could have some specific Raman or Rayleigh signatures,
   an intensity loss of a backscattered signal, such as a Brillouin or Raman or Rayleigh backscattered signal, but such an intensity loss is usually difficult to detect and usually drowned in measurement noise,
fiber backscattered signal 2512 and the address signal 2522 can be different or the same signal; in the preferred embodiment, fiber backscattered signal 2512 and the address signal 2522 are the same signal because this has the technical advantage of greater simplicity.

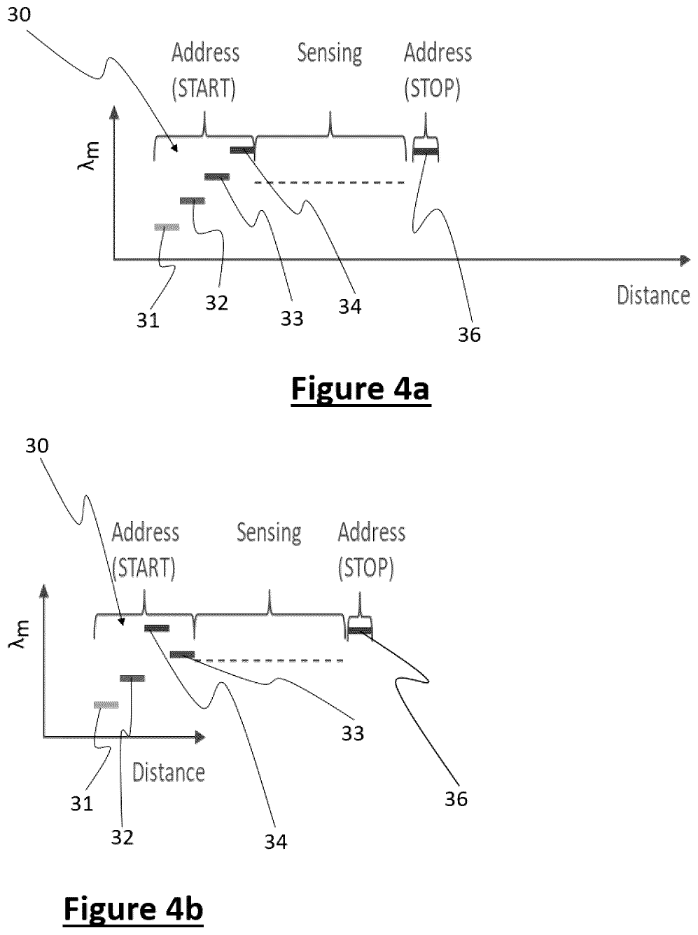

Also, in other examples, the value of each optical address digit 31, 32, 33 or 34 depends:
in a second example of address 30 (illustrated in FIG. 3), on a presence or absence of a Fiber Bragg Grating at a specific location inside the addressing device 1 among several specific locations 11, 12, 13, 14 in the addressing device 1; in this case, each specific location inside the addressing device 1 is one of the optical sections 11, 12, 13, 14 of the addressing device 1 optically linked in series along the optical path, and/or
in a third example of address 30 (illustrated in FIGS. 4a and 4b), on a presence or absence of a specific type of Fiber Bragg Grating inside the addressing device 1. Each Fiber Bragg Grating can be in one of the optical sections 11, 12, 13, 14 of the addressing device 1 optically linked in series along the optical path.

In the second or third example of address 30, each addressing device 1 can comprise several Fiber Bragg Gratings optically linked in series along the optical path.

For example:
in the second example of address 30, the several fiber Bragg Gratings all have a maximum reflection coefficient for the same wavelength λₘ,
in the third example of address 30, the several fiber Bragg Gratings are different and thus have their maximum reflection coefficient for different wavelengths λₘ (i.e. the value of λₘ can differ (or necessary differs) from one FBG to another FBG of the same addressing device 1)

In the second and third example of address 30, each Fiber Bragg Grating used for coding the address 30 is a low reflectivity Fiber Bragg Grating (FBG), having maximum reflection coefficient for λₘ, this maximum reflection coefficient being for example 5% reflectivity or less, e.g. 2% reflectivity or less, e.g. 1% reflectivity or less, e.g. 0.5% reflectivity or less.

In the second and third example of address 30, each end digit 36 is created by the presence of a Fiber Bragg Grating inside the stop device 16.

We are now going to describe with more details the second example of address 30.

The second example of address 30 is illustrated in FIG. 3.

Thus, in this second example:
emitting devices 251 and 252 are the same device or distinct devices,
The fiber excitation signal 2511 and the addressing excitation signal 2521 are the same laser signal or two different laser signals
the system 20 comprises:
   emitting device 251 and analysis device 21 which form together a Raman system, for example Raman DTS system, and
   emitting device 252 and analysis device 21 which form together a FBG interrogator
the fiber backscattered signal 2512 from fiber 151, 152 and/or 153 is a Raman backscattered signal, and
the address signal 2522 for each digit of the address 30 from the addressing device 1 is a back reflection signal, i.e. the back reflection of the excitation pump signal 2521 by one FBG
Analysis device 21 is arranged for analyzing (or is analyzing) the fiber backscattered signal 2512 and each address signal 2522.

Raman is not sensitive to frequency but to intensity only. In theory, it is also possible to build digits 31, 32, 33, 34 by using calibrated loss that can be measured with the Raman system 20. However, making reliable and controllable splice loss is possible but not a preferred embodiment. In addition, adding too much loss will impact the total number of fibers 15 that can be measured with a single interrogator 21, 25.

Within a Raman system 20, the backscattering is shifted by 140 THz with respect to the pump laser 251 and/or 252. For 1550 nm based system 20, this corresponds to 1450 nm and 1650 nm for the Anti-stokes and the Stokes wavelength. The interrogator 21, 25 is arranged (and modified compared to the state of the art) to get access to the specific wavelength of the Rayleigh backscattering of the pump (for the third example described below) and/or the pump reflection (for the present second example) in addition to the other two Anti-stokes and Stokes Raman wavelengths.

In this second example:
low reflectivity Fiber Bragg Grating (FBG, 0.5% reflectivity or less) are used as digits 31, 32, 33, 34, provided that they all have the same wavelength λₘ (for which this Fiber Bragg Grating has a maximum reflection coefficient) matching the wavelength of the excitation pump signal from emitting device 25.

In each addressing device 1:
a first Fiber Bragg Grating (FBG) is used in optical section 10 (illustrated in FIG. 1, this section 10 is not existing in the first example previously described) of addressing device 1. This first FBG is not coding for the address 30, but is just indicating the beginning of the address 30, i.e. that an address 30 will follow; nevertheless, this first FBG is optional, because it is easier to have this first FBG as the first address digit. Else, a FBG is wasted for coding an address,
then, after (along the optical path) this first FBG, N (for example N=4) Fiber Bragg Gratings (FBG) follow (for each FBG: if present, back reflection, bit=1, if absent, bit=0), each one of these FBG corresponding to one of the optical section respectively 11, 12, 13, 14 of addressing device 1 and thus to one of the digits respectively 31, 32, 33 or 34 of the address 30; if N=4, this provides 16 addresses.

Each stop device 16 comprises one single FBG as STOP digit 36.

Additional FBGs can be used in each addressing device 1 to provide more addresses.

The FBGs being all at the same wavelength λₘ, they are spaced by a fiber length which is slightly longer than the spatial resolution of interrogator 21, 25.

There is still a tradeoff with the induced losses, given the fact that the optical budget of a Raman system is limited.

The address 30 is thus coded this way: the value of the n^{th} digit of the address 30 is:
“1” or “YES” if a reflection by a Fiber Bragg Grating is detected at the n^{th} optical section 11, 12, 13, or 14 by analysis device 21, or
“0” or “NO” if no reflection by a Fiber Bragg Grating is detected at the n^{th} optical section 11, 12, 13, or 14 by analysis device 21.

For example, in FIG. 3, the address 30 comprises four digits and is “1” “0” “0” “1” (or “YES” “NO” “NO” “YES”).

We are now going to describe with more details the third example of address 30.

This example will be described only for its differences compared to the second example.

The Rayleigh DAS is normally working at a fixed wavelength, like the Raman DTS. It could therefore be used to read an FBG address too. The Rayleigh DAS laser wavelength can be easily tuned (scanned) so that FBGs with slightly different wavelengths λₘ could be used

The third example of address 30 is illustrated in FIGS. 4a and 4b.

In this third example:
emitting devices 251 and 252 are the same device or distinct devices,
The fiber excitation signal 2511 and the addressing excitation signal 2521 are the same laser signal or two different laser signals
the system 20 comprises:
   emitting devices 251 and analysis device 21 which form together a Raman system, for example Raman DTS system, and
   emitting device 252 and analysis device 21 which form together a Rayleigh OTDR interrogator
the fiber backscattered signal 2512 from fiber 151, 152 and/or 153 is a Raman backscattered signal (using DTS), and
the address signal 2522 for each digit of the address 30 from the addressing device 1 is a Rayleigh backscattered signal backscattered by a FBG,
Analysis device 21 is arranged for analyzing (or is analyzing) the fiber backscattered signal 2512 and each address signal 2522.

In this third example, one could use an independent OTDR/FBG interrogator 21, 25 to measure the addresses and the position of fibers 15 and then transfer the information to the Raman DTS (manually/automatically) 21, 25 (same reference numbers in FIG. 1) in order to build the distance scale.

This requires that the exact laser wavelength of the OTDR and of the Raman are known, or better, are identical, to ensure that the distance scaling is the same for both interrogators.

Using a simple OTDR (no laser wavelength scan), all the FBGs must be at the same wavelength λₘ. This is the binary code described for the second example of code 30. However, FBGs are not designed normally to have all at the same wavelength λₘ. In sensing, they are spread over the optical spectrum, in exactly the same way as it is done for the Brillouin first example. Thus, in the third example, N (N being an integer) FBGs for coding an address 30 will work as N different shifts v_{B} of the first example of address 30.

Thus, in the third example of address 30, the FBG based address 30 can be read with an FBG interrogator 21, 25, namely a tunable laser or a white light source. Here again, matching the laser wavelength or having access to the exact laser wavelength between the OTDR and the DTS/DSS/DAS is important in order to match the distance scale.

There is no need for a given length between the FBGs (a normal FBG interrogator 21, 25 does not distinguish distance and works with continuous wave signal). Thus, FBGs, can be understood as being spatially superimposed. From this point of view, the two addresses 30 in FIGS. 4a and 4b are thus identical

In this third example, with 4 FBGs there are only 4 digits available for a total of 16 addresses. To distinguish START digits from STOP digits, a START address made of a single digit cannot have the same FBG than the STOP address. In other words, the START address 0001 is forbidden as the final is the same as the START one (loosing direction).

Similarly, the address 0000 is forbidden, as the START cannot be found.

Thus, 14 addresses and fibers 15 can be distinguished.

This approach is effective for spaces, as one could think of writing the FBGs close to each other. This would limit the length and the space required to protect the address.

Thus, the address 30 is coded this way: the value of the n ^{th} digit of the address 30 is:
“1” or “YES” if a reflection by a Fiber Bragg Grating of the n^{th} type (each type of Fiber Bragg Grating being defined by a specific value of wavelength λₘ for which this Fiber Bragg Grating has a maximum reflection coefficient) at any one of the optical sections 11, 12, 13, or 14 is detected by analysis device 21, or
“0” or “NO” if no reflection by a Fiber Bragg Grating of the n^{th} type (each type of Fiber Bragg Grating being defined by a specific value of wavelength λₘ for which this Fiber Bragg Grating has a maximum reflection coefficient) at any one of the optical sections 11, 12, 13, or 14 is detected by analysis device 21.

For example:
In FIGS. 4a and 4b, four types of Fiber Bragg Grating having four different values of λₘ are used
in FIG. 4a, the address 30 comprises four digits and is “1111” (or “YES” “YES” “YES” “YES”),
in FIG. 4b, the address 30 comprises four digits and is also “1111” (or “YES” “YES” “YES” “YES”),
this illustrates that FBGs can be understood as being spatially superimposed, and from this point of view the two addresses 30 in FIGS. 4a and 4b are thus identical.

Nevertheless, some FBG interrogators 21, 25 are not only looking at the spectrum, but can also be arranged for looking at the time of flight and thus at the position along the addressing device 1. Such a system 20 would work exactly as a Brillouin one of the first example of address 30, thus providing 256 addresses on the 4 digits and not just 14.

It could be considered, should the laser in the Raman DTS be tunable, to use the Raman interrogator itself as a FBG interrogator. In this case, the FBGs could be arranged such as DTS measurement is performed at a wavelength different from the address to make sure that there are no induced losses. The system would work as a Brillouin approach of the first example, featuring 256 addresses for 4 digits.

The previously described second and third example of address 30 (for which the value of each optical address digit depends on a presence or absence of a specific type of Fiber Bragg Grating inside the addressing device and/or on a presence or absence of a Fiber Bragg Grating at a specific location inside the addressing device among several specific locations (11, 12, 13, 14) in the addressing device) can be generalized:
fiber backscattered signal 2512 can be a Brillouin backscattered signal, a Raman Backscattered signal, or a Rayleigh Backscattered signal, for various possibilities a measured parameters (temperature, strain, vibrations, etc.) of fiber(s) 15; in some implementations, fiber backscattered signal 2512 is a Raman Backscattered signal (for measuring at least one temperature of fiber(s) 15), or a Rayleigh Backscattered signal (for measuring at least one vibration of fiber(s) 15), and/or
address signal 2522 can be a signal equal to or proportional to or depending on, by order of preference:
   one among:
      a wavelength or frequency or wavenumber of a back reflection signal; this case corresponds to the previously described second example of address 30,
      a wavelength or frequency or wavenumber of Rayleigh backscattered signal; this case corresponds to the previously described third example of address 30,
   a wavelength or frequency or wavenumber of Raman backscattered signal; but this could disturb a Raman measurement performed on fibers 151, 152, 153 if fiber backscattered signal 2512 is a Raman Backscattered signal,
   a wavelength or frequency or wavenumber of a Brillouin backscattered signal; this is not the preferred embodiment, as the first example of address 30 seems simpler for Brillouin backscattering,
   an intensity loss of a backscattered signal, such as a Brillouin or Raman or Rayleigh backscattered signal, but such an intensity loss is usually difficult to detect and usually drowned in measurement noise,
fiber backscattered signal 2512 and the address signal 2522 can be different or the same signal; in the preferred embodiment, fiber backscattered signal 2512 and the address signal 2522 are not both a Raman backscattered signal.

Of course, the disclosure is not limited to the examples which have just been described and numerous amendments can be made to these examples without exceeding the scope of the disclosure.

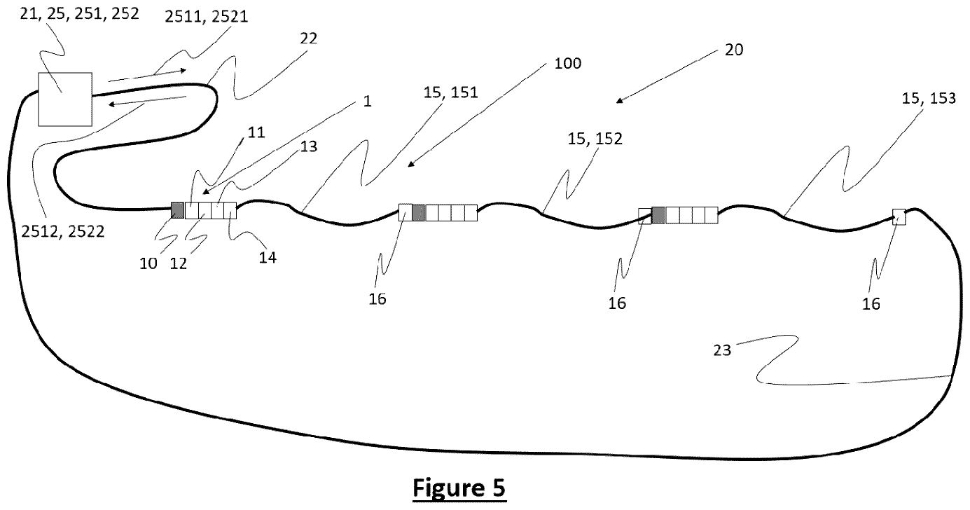

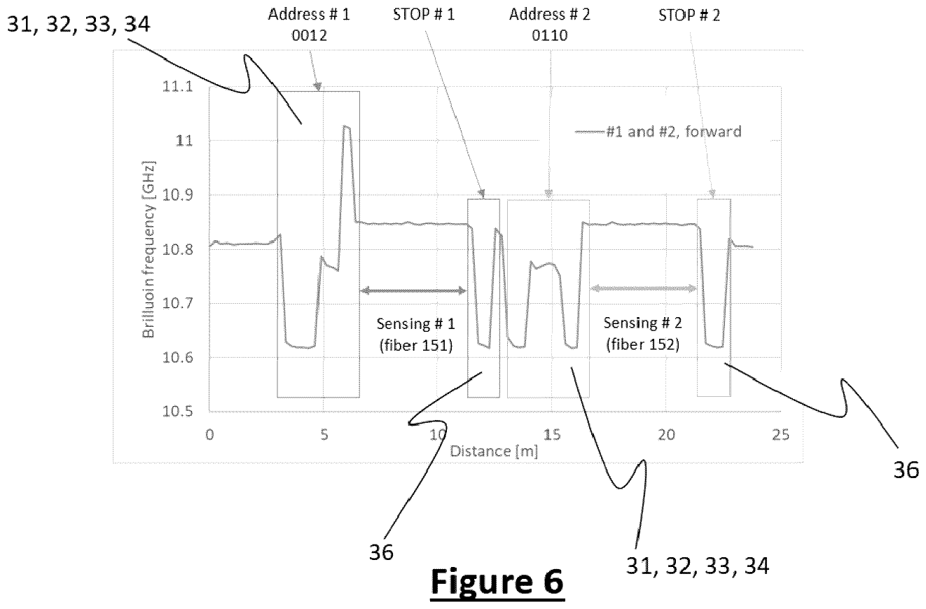

For example, compared to FIG. 1:
fiber 23 can be deleted and is not necessary, in particular if no probe signal is needed, and/or
fibers 24 can be removed as illustrated in FIG. 5, and/or
each stop device 6 can be removed, for example if one considers that the addressing device 1 of a fiber 152 is the stop device of the previous fiber 151.

Of course, the different characteristics, forms, variants and embodiments of the disclosure can be combined with each other in various combinations to the extent that they are not incompatible or mutually exclusive.

1. An addressing device arranged for being associated with an addressable optical fiber and arranged to give an optically coded address to the addressable optical fiber with which it is arranged to be associated, the optically coded address comprising:
a plurality of optical address digits, the addressing device being arranged so that each of the optical address digits is created by an address signal, each address signal of each optical address digit coming from a different optical section of the addressing device.

2. The addressing device according to claim 1, comprising several optical sections, each address signal of each optical address digit coming from a different optical section and being a signal equal to or proportional to or based on:
a wavelength or frequency or wavenumber of a backscattered signal, or
a wavelength or frequency or wavenumber of a back reflection signal, or
an intensity loss of a backscattered signal.

3. The addressing device according to claim 1, wherein each address signal is a Brillouin backscattered signal and a value of each optical address digit is based on one or more of:
a Brillouin frequency shift
a material and/or structure, or
a physical parameter
of a section of optical fiber in the addressing device, coding for this optical address digit.

4. The addressing device according to claim 1, comprising different sections of optical fibers linked in series and having one or more of different Brillouin frequency shifts, different materials, different structures, or different physical parameters.

5. The addressing device according to claim 1, comprising different sections of optical fibers linked in series, wherein each section is configured to receive a different strain.

6. The addressing device according to claim 1, wherein a value of each optical address digit is based on one or more of a presence or absence of a type of Fiber Bragg Grating inside the addressing device or a presence or absence of a Fiber Bragg Grating at a location inside the addressing device among several specific locations in the addressing device.

7. The addressing device according to claim 1, comprising several Fiber Bragg Gratings linked in series.

8. A system for addressing optical fibers, comprising:
a plurality of addressable optical fibers arranged for light to travel through them along an optical path,
an addressing device associated to each addressable optical fiber, wherein:
each addressing device associated with an addressable optical fiber being arranged to give an optically coded address to the addressable optical fiber with which it is associated different from an address of another addressable optical fiber,
each associated addressing device and addressable optical fiber forming a part of the optical path distinct from the other parts of the optical path,
each address includes a plurality of optical address digits, each addressing device is arranged so that each of the optical address digits of the address given by this addressing device is created by an address signal coming from this addressing device,
an analysis device configured to:
receive at least one fiber backscattered signal from at least one of the addressable optical fibers, and
for each addressable optical fiber from which a fiber backscattered signal is received, identify this addressable optical fiber by using address signals of the optical address digits coding for the address of this addressable optical fiber.

9. The system according to claim 8, wherein each addressable optical fiber is surrounded, along the optical path:
by its associated addressing device on one end of the addressable optical fiber, and
by a stop device on another end of the addressable optical fiber, the stop device being arranged for coding for an end of the addressable optical fiber with a least one end digit created by an end signal coming from the stop device.

10. A method for addressing optical fibers, implemented in a system including:
a plurality of addressable optical fibers arranged for light to travel through them along an optical path,
an addressing device, associated to each addressable optical fiber
each associated addressing device and addressable optical fiber forming a part of the optical path distinct from another part of the optical path,
the method comprising:
for each addressing device associated with an addressable optical fiber, generating an optically coded address to the addressable optical fiber with which it is associated different from an address of the another addressable optical fiber, each optically coded address including a plurality of optical address digits, each optical address digit of the optically coded address given by this addressing device being created by an address signal coming from the addressing device,
receiving at least one fiber backscattered signal from at least one of the addressable optical fibers, and
for at least one addressable optical fiber from which a fiber backscattered signal is received, identifying this addressable optical fiber by using the address signals of the optical address digits coding for the address of this addressable optical fiber.

11. The method according to claim 10, wherein the fiber backscattered signal is received from at least one of the addressable optical fibers, each address signal being generated from a same excitation signal or pump signal.

12. The method according to claim 11, wherein each addressing device comprises several optical sections, each address signal of each digit coming from a different optical section and being a signal equal to or proportional to or based on:
a wavelength or frequency or wavenumber of a backscattered signal, or
a wavelength or frequency or wavenumber of a back reflection signal, or
an intensity loss of a backscattered signal.

13. The method according to claim 10, wherein each address signal is a Brillouin backscattered signal and the value of each optical address digit is based on:
a Brillouin frequency shift,
a material and/or structure, or
a physical parameter
of a section of optical fiber of optical fibers in the addressing device, coding for this optical address digit.

14. The method according to claim 12, wherein each addressing device comprises different sections of optical fibers linked in series along the optical path and having one or more of different Brillouin frequency shifts, different materials, structures, or physical parameters.

15. The method according to claim 10, wherein each addressing device comprises different sections of optical fibers linked in series, each section configured to receive a different strain.

16. The method according to claim 10, wherein a value of each optical address digit is based on a presence or absence of a specific type of Fiber Bragg Grating inside the addressing device and/or on a presence or absence of a Fiber Bragg Grating at a specific location inside the addressing device among several specific locations in the addressing device.

17. The method according to claim 10, wherein each addressing device comprises a plurality of Fiber Bragg Gratings linked in series along the optical path.

18. The method according to claim 17, wherein each optical address digit is a bit having only two possible values.

19. The method according to claim 17, wherein each optical address digit has at least three possible values.

20. The method according to claim 17, wherein each addressable optical fiber is surrounded, along the optical path:
by its associated addressing device on one end of the addressable optical fiber, and
by a stop device on another end of the addressable optical fiber, the stop device being arranged for coding for an end of the addressable optical fiber with a least one end digit created by an end signal coming from the stop device.
